(19) United States
(12) Patent Application Publication
(10) Pub. No.: US 2023/0297605 A1
(43) Pub. Date: Sep. 21, 2023

(54) GENERATING A CONVERSATION SUMMARY USING A LABEL SPACE

(71) Applicant: ASAPP, INC., New York, NY (US)

(72) Inventors: Xinyuan Zhang, Jersey City, NJ (US); Derek Chen, Brooklyn, NY (US); Yi Yang, Long Island City, NY (US)

(21) Appl. No.: 17/696,608

(22) Filed: Mar. 16, 2022

(51) Int. Cl. G06F 16/34; G06F 40/35; G10L 15/26

(52) U.S. Cl. CPC G06F 16/345; G06F 40/35; G10L 15/26

(57) ABSTRACT

A summary of a conversation may be generated using a neural network and a label space. Conversation turns of the conversation may be processed with a neural network, such as a classifier neural network, to compute label scores for two or more labels. The label scores for the conversation turns may be processed to compute tag scores for tags of the conversation turns. A subset of the tags may be selected using the tag scores where the selected tags represent aspects of the conversation. Text representations of the selected tags may be obtained, and the text representations may be used for generating the conversation summary.

### BACKGROUND

In many applications, it may be needed for a person to review a previous conversation between two or more users. For example, a person could review a text transcript of a conversation to understand the subject matter of the conversation. Reviewing an entire conversation may take significant time since a conversation between users may be long in duration, may repeat information, and may include details that are not relevant to the main purpose of the conversation.

Accordingly, it may be desired to create a summary of a conversation between two or more users to allow a person to quickly understand the subject matter of the conversation without reviewing the entire conversation. An effective conversation summary may concisely represent the important topics and details of the conversation.

### SUMMARY

In some aspects, the techniques described herein relate to a computer-implemented method, including: receiving conversation information, wherein: the conversation information includes a sequence of conversation turns, the sequence of conversation turns includes a first conversation turn and a second conversation turn, the first conversation turn corresponds to first text, and the second conversation turn corresponds second text; computing label scores by processing the sequence of conversation turns with one or more neural networks, wherein computing the label scores includes: computing, for the first conversation turn, first label scores for a first label and second label scores for a second label, and computing, for the second conversation turn, third label scores for the first label and fourth label scores for the second label; computing tag scores for tags by processing the label scores, wherein computing the tag scores includes: computing, for the first conversation turn, a first tag score for a first tag using the first label scores and the second label scores, and computing, for the second conversation turn, a second tag score for a second tag using the third label scores and the fourth label scores; selecting a subset of the tags using the tag scores, wherein selecting the subset of the tags includes selecting the first tag using the first tag score and not selecting the second tag using the second tag score; obtaining a first text representation of the first tag; and generating a conversation summary using the first text representation of the first tag.

In some aspects, the techniques described herein relate to a computer-implemented method, wherein the first text of the first conversation turn was obtained by performing speech recognition of audio.

In some aspects, the techniques described herein relate to a computer-implemented method, wherein computing the first label scores includes processing the first text with a convolutional neural network.

In some aspects, the techniques described herein relate to a computer-implemented method, wherein computing the first tag score includes processing a first label score of the first label scores and a second label score of the second label scores.

In some aspects, the techniques described herein relate to a computer-implemented method, wherein computing the first tag scores includes multiplying a first label score of the first label scores and a second label score of the second label scores.

In some aspects, the techniques described herein relate to a computer-implemented method, wherein selecting the subset of the tags includes determining a similarity between the first tag and the second tag.

In some aspects, the techniques described herein relate to a computer-implemented method, wherein: selecting the subset of the tags includes selecting a third tag of a third conversation turn; the computer-implemented method includes obtaining a third text representation of the third tag; and generating the conversation summary includes concatenating the first text representation of the first tag with the third text representation of a third tag.

In some aspects, the techniques described herein relate to a computer-implemented method, wherein: the first conversation turn corresponds to a first timestamp; the third conversation turn corresponds to a third timestamp; and generating the conversation summary includes ordering the first text representation and the third text representation using the first timestamp and the third timestamp.

In some aspects, the techniques described herein relate to a system, including: at least one server computer including at least one processor and at least one memory, the at least one server computer configured to: receive conversation information, wherein: the conversation information includes a sequence of conversation turns, the sequence of conversation turns includes a first conversation turn and a second conversation turn, the first conversation turn corresponds to first text, and the second conversation turn corresponds second text; compute label scores by processing the sequence of conversation turns with one or more neural networks, wherein computing the label scores includes: computing, for the first conversation turn, first label scores for a first label and second label scores for a second label, and computing, for the second conversation turn, third label scores for the first label and fourth label scores for the second label; compute tag scores for tags by processing the label scores, wherein computing the tag scores includes: computing, for the first conversation turn, a first tag score for a first tag using the first label scores and the second label scores, and computing, for the second conversation turn, a second tag score for a second tag using the third label scores and the fourth label scores; select a subset of the tags using the tag scores, wherein selecting the subset of the tags includes selecting the first tag using the first tag score and not selecting the second tag using the second tag score; obtain a first text representation of the first tag; and generate a conversation summary using the first text representation of the first tag.

In some aspects, the techniques described herein relate to a system, wherein: the first conversation turn corresponds to a first user identifier; the second conversation turn corresponds to a second user identifier; and obtaining the first text representation of the first tag includes using the first user identifier.

In some aspects, the techniques described herein relate to a system, wherein the first user identifier corresponds to a customer and the second user identifier corresponds to an agent.

In some aspects, the techniques described herein relate to a system, wherein obtaining the first text representation of the first tag includes retrieving the first text representation of the first tag from a data store.

In some aspects, the techniques described herein relate to a system, including presenting the conversation summary to a user.

In some aspects, the techniques described herein relate to a system, including receiving an input from the user to modify the conversation summary.

In some aspects, the techniques described herein relate to a system, including storing the conversation summary in a data store, wherein the data store is indexed using the first label.

In some aspects, the techniques described herein relate to a system, wherein computing the first label scores includes processing the first text with a classifier.

In some aspects, the techniques described herein relate to one or more non-transitory, computer-readable media including computer-executable instructions that, when executed, cause at least one processor to perform actions including: receiving conversation information, wherein: the conversation information includes a sequence of conversation turns, the sequence of conversation turns includes a first conversation turn and a second conversation turn, the first conversation turn corresponds to first text, and the second conversation turn corresponds second text; computing label scores by processing the sequence of conversation turns with one or more neural networks, wherein computing the label scores includes: computing, for the first conversation turn, first label scores for a first label and second label scores for a second label, and computing, for the second conversation turn, third label scores for the first label and fourth label scores for the second label; computing tag scores for tags by processing the label scores, wherein computing the tag scores includes: computing, for the first conversation turn, a first tag score for a first tag using the first label scores and the second label scores, and computing, for the second conversation turn, a second tag score for a second tag using the third label scores and the fourth label scores; selecting a subset of the tags using the tag scores, wherein selecting the subset of the tags includes selecting the first tag using the first tag score and not selecting the second tag using the second tag score; obtaining a first text representation of the first tag; and generating a conversation summary using the first text representation of the first tag.

In some aspects, the techniques described herein relate to one or more non-transitory, computer-readable media, wherein the first label corresponds to dialog acts and the second label corresponds to topics.

In some aspects, the techniques described herein relate to one or more non-transitory, computer-readable media, wherein selecting the subset of the tags includes selecting tags above a threshold.

In some aspects, the techniques described herein relate to one or more non-transitory, computer-readable media, wherein selecting the subset of the tags includes determining a similarity between the first tag and the second tag.

### BRIEF DESCRIPTION OF THE FIGURES

The invention and the following detailed description of certain embodiments thereof may be understood by reference to the following figures:

FIG. 1 is an example system where users may engage in conversations.

FIG. 2 is a flowchart of an example method for generating and indexing a summary of a conversation.

FIG. 3 is an example conversation between two users.

FIG. 4 is an example conversation between two users where label scores are computed for the conversation turns for labels of a label space.

FIG. 5 is an example conversation between two users where the conversation turns have been assigned tags using the labels from the label space.

FIG. 6 is an example conversation between two users where tags of conversation turns have been selected using the tag scores.

FIG. 7 is an example list of selected tags from a conversation between two users.

FIG. 8 is an example list of text representations generated for the selected tags.

FIG. 9 is a conversation summary generated by combining text representations of the selected tags.

FIG. 10 is an example system for computing tag scores for a conversation turn.

FIG. 11 is an example system for generating a conversation summary by processing tags and tag scores for conversation turns.

FIG. 12 is a flowchart of an example method for generating a summary of a conversation using a label space.

FIG. 13 illustrates components of one implementation of a computing device 1300 for implementing any of the techniques described herein.

### DETAILED DESCRIPTION

Users may engage in conversations for a variety of purposes and through a variety of channels. For example, conversations may use text messages or may be conducted over audio and/or video. The techniques described herein may be used for any type of conversation and any channel or medium for conducting conversations (e.g., in person, phone, video, email, SMS, etc.).

In some instances, it may be desired to generate a text summary of a conversation. For example, a transcript of a conversation (e.g., obtained from text messages or via speech recognition of an audio conversation) may be processed to generate a text representation of the conversation that allows a person to easily understand the important topics or other aspects of the conversation.

To improve the quality of a conversation summary, the summary may include all important details of the conversation, avoid repetition, and omit details that are not relevant to the main purpose of the conversation. Existing tools for generating conversation summaries may not provide conversation summaries of sufficient quality for some applications.

In some implementations, a conversation summary may be generated using a label space and/or tags. Text of the conversation may be automatically processed to assign one more or labels to the text. Any appropriate labels may be used. For example, a label may correspond to selecting a dialog act of the text from a set of possible dialog acts. For another example, a label may correspond to selecting a topic of the text from a set of possible topics. The labels may be combined to generate tags that describe the text. The most relevant tags may be identified and processed to generate a text summary of the conversation.

The generation of high-quality conversation summaries may provide business value to companies. Considerable time and cost is required for an employee to review a conversation transcript. An employee may review a conversation summary much more quickly and thus save considerable time. An employee may also obtain a better understanding of a conversation since speed reading a conversation transcript may result in missing or misunderstanding important aspects of the conversation. A better understanding of the conversation may allow the employee to provide better services or make better business decisions based on the understanding of the conversation. Accordingly, a business may decrease costs and also improve the quality of their services through using high quality conversation summaries.

In some instances, it may be desired to facilitate the search and retrieval of conversations and/or conversation summaries according to various aspects of conversations. Conversations and/or summaries may be associated with one or more labels and/or tags corresponding to important aspects of the conversation (e.g., an act or topic of the conversation). For example, conversations and/or summaries may be stored in a database that is indexed according to various conversation labels and/or tags to allow retrieval of conversations and/or summaries according to specified labels and/or tags.

The indexing of conversations and/or conversation summaries may provide business value to companies. Indexing of conversations allows for a better understanding of the substance of conversations and how they relate to the business of the company. For example, the indexing of customer service conversations may help businesses better understand customer complaints and the products or services that are most valued by customers. Businesses may use this information to improve their products and services and increase their profitability.

According to one aspect, the techniques described herein provide improved performance for computing summaries and conversation transcripts within a computer environment. The techniques described herein include improved conversation labeling and processing techniques that preserve conversation structure and capture more aspects of conversation nuances than traditional summarization techniques. Elements of a conversation are labeled and tagged according to two or more configurable categories which provide for capturing aspects of a conversation from multiple dimensions. Categories, labels, and label scoring may be adjusted to allow fast and efficient configuration for different applications, locations, industries, languages, dialects, and the like.

In another aspect, the techniques described herein provide an improvement in adaptability to the performance characteristics of different computing environments. In some implementations, computation of labels and tags for different turns of conversations enables a configurable granularity and complexity of computations. In one configuration, computation of labels and/or tags may involve models that may be confined to the text of one conversation turn and may be suitable for a computing environment with lower memory or computations capabilities. In another configuration, computation of labels may involve models that process text of two or more conversation turns and may be suitable for computing environments with higher memory or computations capabilities.

In another aspect, the techniques described herein provide an improvement to the accuracy and performance of indexing of conversations. In some implementations, turns of a conversation may be indexed using assigned labels. The assigned labels provide for consistent identification of properties and characteristics of the conversations. The techniques provide for the use of consistent labels with a well-defined meaning even if the text of the associated conversations may be of different languages, dialects, types, and the like. Likewise, labels may be shorter than the conversations they are associated with therefore requiring less computer resources for indexing and search than the original conversation.

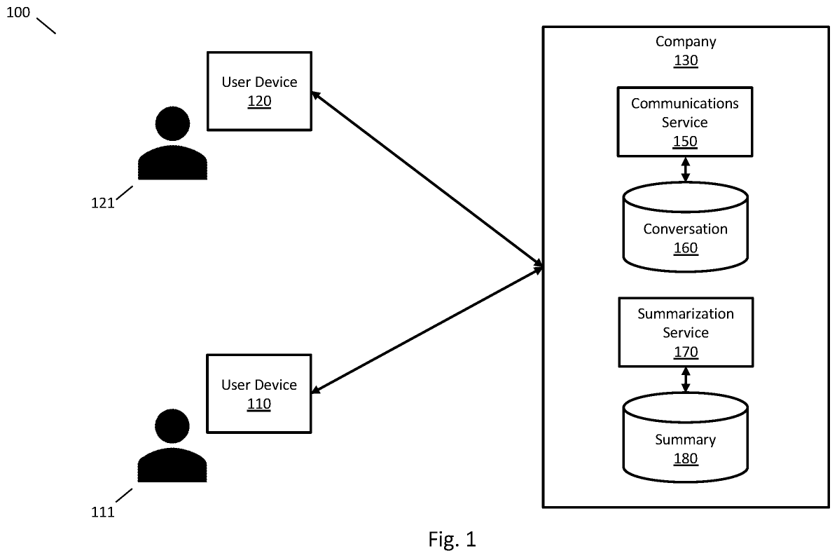

FIG. 1 is an example system 100 where users may engage in conversations. User 111 may use user device 110 to have a conversation with user 121 using user device 120. User 111 and user 121 may be having a conversation for any appropriate purpose, such as a personal conversation or a customer support session. User device 110 and user device 120 may be any appropriate devices, such as a conventional phone, a smart phone, or any other computing device or portable device. The conversation may be through any appropriate channel, such as any combination of text, speech, and video.

Company 130 may provide services relating to the conversation. For example, company 130 may provide a communications service 150 to facilitate the conversation between user 111 and user 121. For example, communications service 150 may relate to facilitating phone calls or text messaging between user 111 and user 121. Communications service 150 may store text of the communications in conversation data store 160. Any appropriate information may be stored in conversation data store 160, such as text of text messages or transcriptions of speech.

Company 130 may also provide a summarization service 170 to facilitate the summarization of conversations. Summarization service 170 may access the text of conversations in conversation data store 160 and process the text to generate a conversation summary. The conversation summary may be stored in summary data store 180. The conversation summary may be accessed by other users or may be indexed to facilitate search and retrieval.

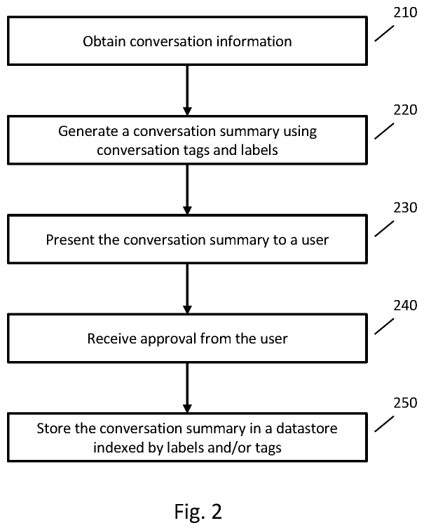

FIG. 2 is a flowchart of an example method for generating and indexing a summary of a conversation.

At step 210, conversation information is obtained. Any appropriate conversation information may be obtained using any appropriate techniques. For example, the conversation information may correspond to text messages or may correspond to transcribed speech. The conversation information may be represented as a sequence of conversation turns, where each conversation turn corresponds to a communication of a user. The conversation turns may include other information, such as a type of user (e.g., customer or customer service representative), an identity of a user (e.g., a numerical ID or a name), or a timestamp of the communication.

As used herein, a conversation turn corresponds to any utterance of a user. A conversation turn may correspond to any quantity of text or speech, such as a word, phrase, part of a sentence, complete sentence, or multiple sentences. The conversation turns may generally alternate between users, but conversation turns of users may overlap in time, and a single user may provide more than one conversation turn before the other user provides a conversation turn.

At step 220, a conversation summary is generated using any of the techniques described herein. For example, conversation turns may be processed to determine labels and/or tags. The labels and/or tags may then be used to generate a text summary of the conversation. In some implementations, the summary may be stored and/or indexed for later use, or the conversation summary may be presented to a user for approval and/or possible modification.

At step 230, the conversation summary may be presented to a user. For example, the summary may be presented to one of the users in the conversation or to another user. This step is optional and may be omitted.

At step 240, approval may be received from the user or the user may modify the summary. For example, the user may edit the text of the conversation summary or modify labels and/or tags corresponding to the conversation summary. This step is optional and may be omitted.

At step 250, the conversation summary may be stored in a data store. The conversation summary may be stored in the same data store used to store the text of the conversation or in a different data store. In some implementations, the summary may be indexed according to labels and/or tags of the conversation summary to facilitate search and retrieval of the summary and/or the corresponding conversation.

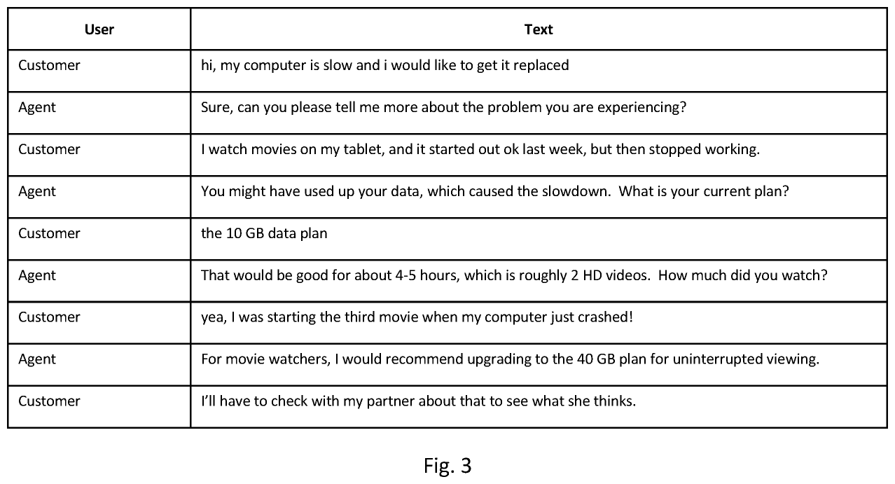

FIG. 3 is an example conversation between two users. In FIG. 3, the two users are a customer of a company and an agent or customer service representative of the company, but the techniques described herein may be used for any type of conversation. FIG. 3 illustrates the conversation turns showing the type of user who generated a communication and the text of the communication, but any other appropriate information may be stored with the conversation, such as an identity of the users and timestamps for the conversation turns.

The conversation turns may be processed to determine one or more labels of a label space to apply to the conversation turns. Any appropriate label space may be used. A label space may include one or more labels, and each label in the label space may have one or more values (including an optional value of “none” indicating that no value of a label applies). In some implementations, a label space may include labels for one or more of an intent, a dialogue act, a topic, a status, or a modifier of a status. A label and its values may correspond to any aspects of a conversation that facilitate processing of a conversation, such as summarizing a conversation or indexing a conversation.

An intent (or natural language intent) may correspond to what a user is attempting to accomplish within a conversation, and the possible intents may correspond to the purpose or type of conversation. For example, for customer support conversations, the possible intents may correspond to the products and services and other operations of the company, such as intents corresponding to the following: pay bill, change address, cancel service, add service, etc.

A dialogue act may correspond to classification of the act being performed by the person in providing a communication, such as a function of the communication. In some implementations, the label space may any of the following dialogue acts:
Open: a greeting, such as “hello”
Close: a phrase for ending a conversation, such as “goodbye”
Inform: a user providing information about a preference or fact
Check: a user requesting to find status or information, such as “has my package arrived?”
Fix: a user reporting that something is broken, such as “the website isn't loading”
Describe: a user describing a scenario, such as “the router lights are blinking”
Instruct: a user giving instructions or advice, such as “try turning it off and on again”
Offer: a user offering a solution to a problem, such as “would you like to sign up for the 40 GB plan”
Accept: a user accepting an offer, such as “yes, let's go with that plan”
Reject: a user rejecting an offer, such as “no, I don't want that”
Question: a user asking a question, such as “when did that email arrive?”
Answer: a user answering a question, such as “yes, that's right”
Acknow: a user signifying acknowledgement, inviting the speaker to continue the conversation, such as “ok, I got it”
Confuse: a user signifying confusion, such as “can you repeat that?”

A topic may correspond to a subject of a communication or an object being discussed in a communication, and the possible topcis may correspond to the purpose or type of conversation. For example, for a customer support conversations for an airline, the possible topics may correspond to the following: arrival city, departure city, airport, etc.

A status may be a value corresponding to a topic, and the possible values may correspond to the purpose or type of conversation. For example, for a customer support conversations for an airline, the values for arrival city and departure city may correspond to the cities served by the airline. In some implementations, the possible values may be defined ahead of time. In some implementations, the possible values may be open ended and the values may be obtained from the text. For example, the topic may be a phone number, a person may include their phone number in a communication, and the value of the phone number may be extracted from the communication (e.g., using named entity recognition or regular expressions).

A modifier of a status may provide additional information relating to the status. Any appropriate modifiers may be used, such as the following modifiers:
Not: indicates that the status is not present, such as when user states “I can't see the button” for a status that the button is not visible
A number: indicates a frequency of occurrence of the status, such as when a user states “I've tried logging 3 times” for a status of 3 attempts
Past: indicates that the status occurred in the past, such as when a user states “I paid that bill yesterday”
Present: indicates that the status is currently occurring, such as when a user states “Can you help me pay my bill now?”
Future: indicates that the status will occur in the future, such as when a user states “I will pay my bill tomorrow”

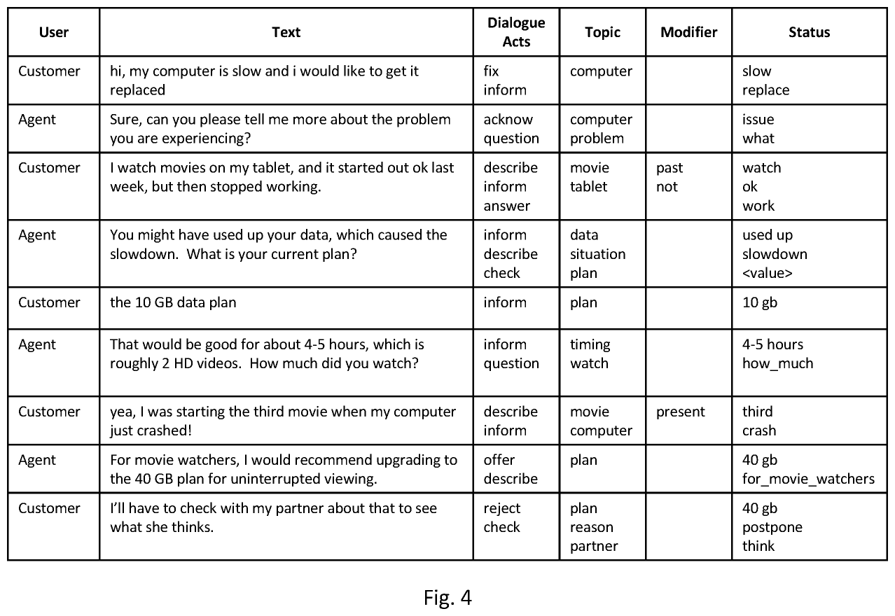

FIG. 4 is an example conversation between two users where label scores are computed for the conversation turns for labels of a label space. Any appropriate label space may be used such as a label space that includes any of the labels described herein. In the example of FIG. 4, the label space includes dialogue act, topic, status, and a modifier of the status.

In some implementations, a label score may be computed for each possible value of a label. For example, for the dialogue acts label, where there are 14 possible values of the label, 14 dialogue acts label scores may be computed for each conversation turn. For clarity of presentation, FIG. 4 shows label values corresponding to higher label scores (e.g., label scores above threshold).

For example, for the first conversation turn of FIG. 4, the dialogue act “fix” may have a higher label score because the user would like to get their computer fixed and the act “inform” may have a higher label score because the user is informing the agent that her computer is slow. The topic “computer” may have a higher label score because it is the subject of both dialogue acts. The statuses of “slow” and “replace” may have a higher label scores because they both correspond to the status of the computer. The Modifier label may not have any values indicated where the label scores for the possible values all have low scores (or a label value of “none” has a higher value).

Any appropriate techniques may be used to determine label scores for the conversation turns. In some implementations, a classifier may be used to process a conversation turn and compute label scores (e.g., probabilities or likelihoods) for different values of a label. For example, where a label has 5 possible values, the classifier may output a probability for each label value that the label value corresponds to the conversation turn (and possibly a sixth value indicating that none of the label values correspond to the conversation turn). A different classifier may be used for each value or joint classifiers may be used to compute joint probabilities for combinations of some or all labels. Techniques for determining label values and label scores are described in greater detail below.

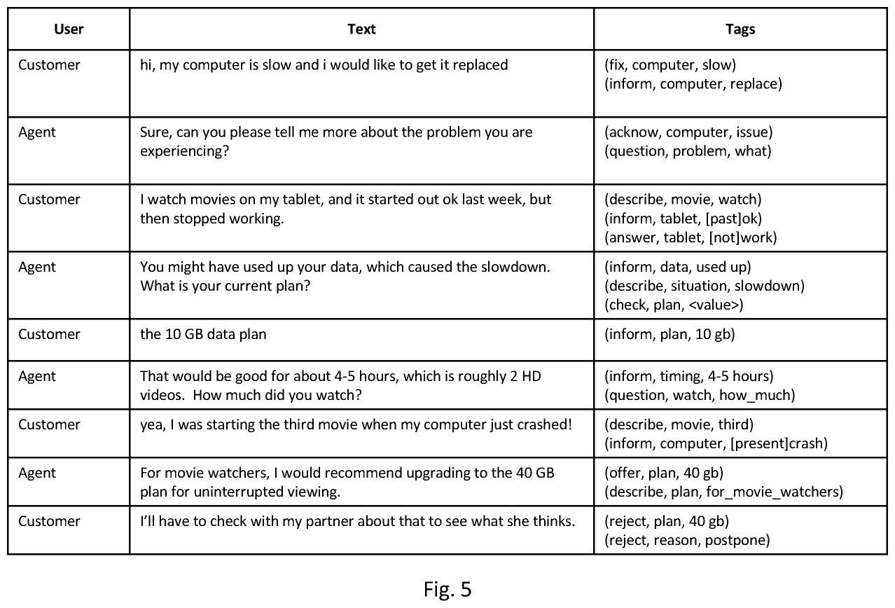

FIG. 5 is an example conversation between two users where the conversation turns have been assigned tags using the labels from the label space. As used herein, a tag is a combination of two or more label values from a label space. In some implementations, the label space may also include labels for a type of user corresponding to a conversation turn or an identity of a user corresponding to a conversation turn. A tag need not include values for all labels in the label space (or may include a value, such as “none” to indicate that no label value is present), such as when no modifier label is present for a conversation turn. A tag may also be associated with a tag score (e.g., a probability or likelihood). Tags may be determined from label values using any appropriate techniques, such as combinatorically combining label values. In some implementations, a conversation turn may be limited to a single tag, and in some implementations, a conversation turn may have multiple tags. Techniques for determining tags and tag scores are described in greater detail below.

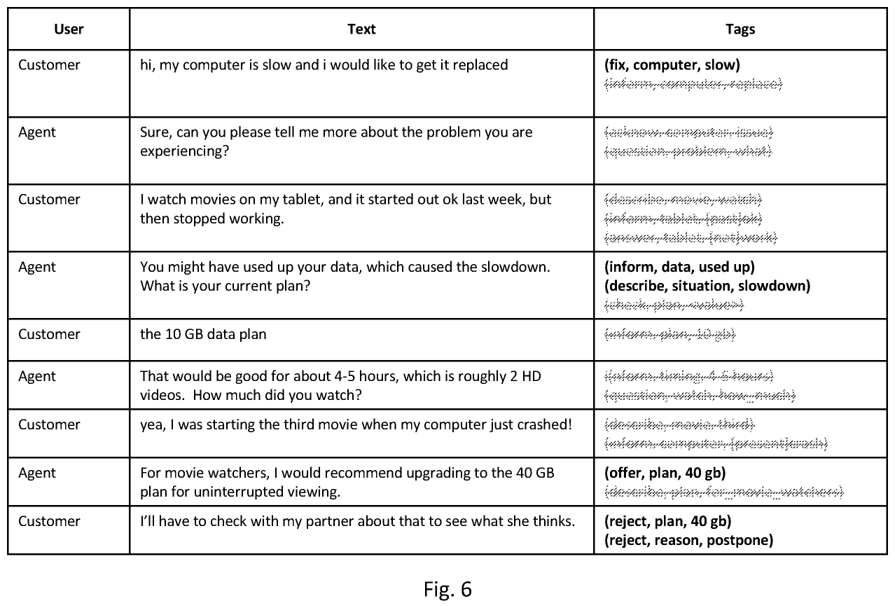

FIG. 6 is an example conversation between two users where tags of conversation turns have been selected using the tag scores. In FIG. 6, the selected tags are indicated in bold font and the tags that are not selected are indicated with overstrike. Any appropriate techniques may be used to select tags using the tag scores. In some implementations, higher scoring tags may be selected. In some implementations, other criteria may be applied, such as rejecting a tag that is too close in meaning to another tag. In some implementations, more than one tag may be selected for a conversation turn, and in some implementations, a conversation turn may be limited to no more than one tag. Techniques for selecting tags using tag scores are described in greater detail below.

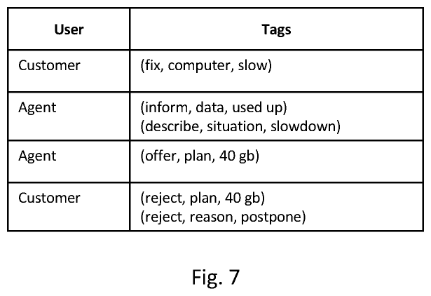

FIG. 7 is an example list of selected tags from a conversation between two users. The selected tags may be used to generate a summary of the conversation as described in greater detail below. In some implementations, the tags may be associated with timing information from the corresponding conversation turns. In some implementations, the selected tags may be ordered in the same order as their corresponding conversation turns. In some implementations, only the selected tags are used to generate a conversation summary, and the conversation text is not needed to generate the summary after selecting the tags.

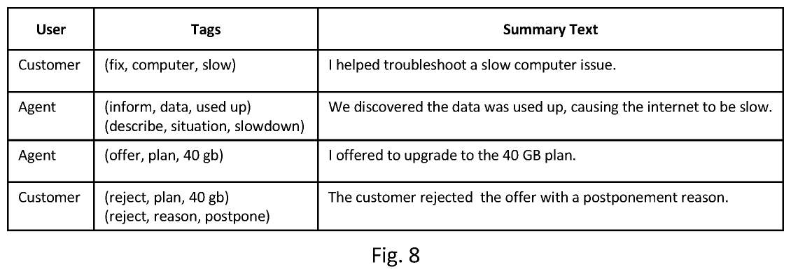

FIG. 8 is an example list of text representations generated for the selected tags. The text representations may be generated using any appropriate techniques, such as described in greater detail below. In some implementations, text representations may be manually generated by a person for each of the possible tags. In some implementations, the text representations may be generated using a mathematical model, such as a neural network.

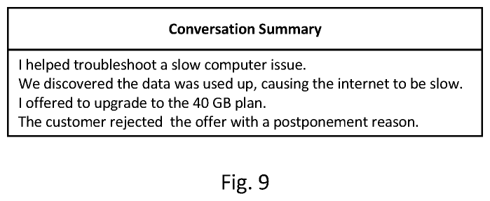

FIG. 9 is a conversation summary generated by combining text representations of the selected tags. The conversation summary may be generated using any appropriate techniques, such as described in greater detail below. In some implementations, the conversation summary may be generated by concatenating the text representations of the selected tags. The conversation summary may be presented using any appropriate techniques, such as a paragraph of text or list of sentences (e.g., as bullet points).

In some implementations, the storing and indexing of a conversation may include storing and/or indexing of one or more tags, labels, and/or a summary of the text. In some cases of resource-constrained devices (such as memory or processor speed), storage and indexing may include only the tags and/or the labels. In some cases, storage and indexing may include tags, labels, and the summary of the text. In some cases, storage and indexing may include storage and indexing of just the summary text.

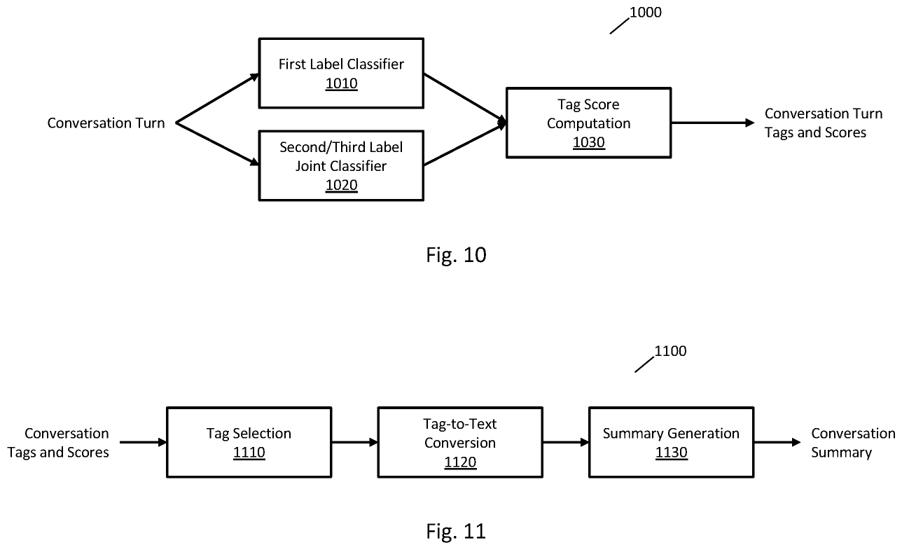

FIG. 10 is an example system 1000 for computing tag scores for a conversation turn.

In FIG. 10, a conversation turn is processed by one or more classifiers. A classifier may perform classification for a single label (such a classifier may be referred to as a single classifier), such as first classifier 1010, or may perform joint classification for more than one label (such a classifier may be referred to as a joint classifier), such as second/third label joint classifier 1020. In some implementations, a single classifier may be used for each label of the label space, one joint classifier may be used for all labels of the label space, or a combination of single and joint classifiers may be used.

A single classifier may compute label scores (e.g., probabilities or likelihoods) for the possible values of the label (and possible an additional score for no label). For example, for a first label with possible values of A1, A2, and A3, the single classifier for the first label may compute a label score for each of A1, A2, and A3. A joint classifier may compute label scores for all possible combinations of values. For example, for a second label with possible values of B1 and B2 and a third label with possible values of C1, C2, and C3, a joint classifier for the second and third labels may compute a label score for each of (B1, C1), (B1, C2), (B1, C3), (B2, C1), (B2, C2), and (B2, C3).

The classifiers may compute the label scores using any appropriate techniques. In some implementations, the text of the conversation turn may be processed to generate one or more convenient representations of the text, such as tokens, word pieces, or byte pairs. The text or a representation of it may then be processed to create embedding vectors or other mathematical representations of the text. In some implementations, the conversation turn (or a processed version of it) may be processed by a mathematical model to compute the label scores. For example, the mathematical model may be a neural network. Any appropriate mathematical model may be used, such as a convolutional neural network, a recurrent neural network, or a transformer neural network. In some implementations, techniques such as max pooling may be used to normalize the length of conversation turns before being processed by a mathematical model (e.g., a convolutional neural network).

In some implementations, the classifiers may process the conversation turns independently of other conversation turns. In some implementations, the classifiers may use information about other conversation turns when processing a conversation turn to better understand a conversation turn in the context of the conversation. For example, in some implementations, the classifiers may process the conversation turns sequentially and retain state information to use information learned from previous conversation turns when processing a current conversation turn. In some implementations, the classifiers may process a sliding window of all conversation turns or a sliding window of conversation turns for a user of the conversation.

Tag score computation component 1030 may receive the label scores and compute tag scores and/or select tags using tag scores. In some implementations, tag score computation component 1030 may receive all the label scores from the classifiers, and in some implementations, tag score computation component 1030 may receive only some of the label scores (e.g., label scores above a threshold).

Tag score computation component 1030 may compute tag scores using any appropriate techniques. In some implementations, tag score computation component 1030 may compute tag scores by determining all possible combinations of label scores from the classifiers. For example, where first classifier 1010 has 3 first label scores and second/third label joint classifier 1020 has 6 second/third label scores, tag score computation component 1030 may determine 18 possible combinations of the first label scores with the second/third label scores. More generally, the total number of combinations may correspond to the product of the number of label scores for each classifier.

A tag score for a tag may be computed from the label scores for the labels corresponding to the tag using any appropriate techniques, such as multiplying or adding the label scores. For example, for a tag (A3, B1, C2), the label scores corresponding to the tag are the label score for the label A3 computed by first classifier 1010 and the joint label score for the labels (B2, C2) computed by second/third label joint classifier 1020. In some implementations, the tag score for the tag (A3, B1, C2) may be computed as the product of the label score for label A3 and the joint label score for the labels (B1, C2).

In some implementations, tag score computation component 1030 may output tags and tag scores for all possible tags for the conversation turn (e.g., 18 possible tags for the example above). In some implementations, tag score computation component 1030 may output a subset of all possible tags for the conversation turn, such as outputting tags and tag scores for tags above a threshold. In some implementations, tag score computation component 1030 may output at most one tag and tag score for each conversation turn.

System 1000 of FIG. 10 may be used to generate tags and tag scores for one or more conversation turns of a conversation. System 1000 of FIG. 10, or variations of it, may also be used for training any of the mathematical models of system 1000, such as mathematical models corresponding to the classifiers. Any of the techniques described herein may also be used for training mathematical models, such as processing the training data using a sliding window of conversation turns when training the classifiers.

FIG. 11 is an example system 1100 for generating a conversation summary by processing tags and tag scores for conversation turns.

In FIG. 11, tag selection component 1110 may process tags and tag scores of a conversation, such as the tags and tag scores determined by system 1000 of FIG. 10. The input to tag selection component 1110 may include tags and tag scores from some or all conversation turns of a conversation. Tag selection component 1110 may select a subset of these tags to use for generating a summary of the conversation. For clarity of presentation, the tags that are input to tag selection component 1110 will be referred to as conversation tags and the tags that are output by tag selection component 1110 will be referred to as summary tags.

Tag selection component 1110 may use any appropriate techniques to select the summary tags from the conversation tags. In some implementations, tag selection component 1110 may select a number of highest scoring tags, such as a number of tags with the highest scores or all tags with a score above a threshold. In some implementations, constraints may be imposed on the tag selection so that the selected tags are unique. For example, prior to tag selection, the highest scoring instance of each tag may be retained, and lower scoring instances of the same tag may be discarded.

In some implementations, constraints may be imposed on tag selection to prevent the selection of tags that have similar meanings to each other. For example, where the top scoring tag is (fix, computer, slow) and the second top scoring tag is (fix, computer, broken), the second top scoring tag may be discarded because its meaning is close to the meaning of the top scoring tag and doesn't provide significant additional information. Any appropriate techniques may be used to determine similarity of meaning between tags, such as semantic representations (e.g., word embeddings), decision trees, or heuristics.

In some implementations, more than one tag may be selected from a single conversation turn. In some implementations, tag selection may be constrained to select no more than one tag for each conversation turn. For example, where one conversation turn has the two highest scoring tags, one of the two highest scoring tags may be selected and the other may be discarded.

In some implementations, the output of tag selection component 1110 may be a list of tags. In some implementations, the tags may be grouped according to their conversation turns as illustrated in FIG. 7. In some implementations, the output may include other information, such as a timestamp, the order of the tags in the conversation, or an identifier of the type of user or actual user of the corresponding conversation turn.

Tag-to-text conversion component 1120 may process the summary tags selected by tag selection component 1110 and generate a text representation to use in the conversation summary.

In some implementations, the text representation may be generated in advance for each tag, and the pre-generated text representation may be selected for each of the tags. The text representation may be generated in advance using any appropriate techniques. For example, the text representation may be generated by a person or generated using a mathematical model, such as a neural network.

In some implementations, mathematical models may be used to generate text representations for the tags. For example, a mathematical model, such as a neural network, may process the tags and generate a text representation for each of the tags. Where two tags correspond to the same conversation turn, a single text representation may be generated for the conversation turn, such as illustrated in the second and fourth rows of FIG. 8.

Summary generation component 1130 may process the text representations output by tag-to-text conversion component 1120 to generate a conversation summary to be presented to a user. Summary generation component 1130 may use any appropriate techniques such as concatenating the text representations or generating a bullet-point list for presentation to a user.

The conversation summary may then be presented to a user, and in some implementations, the user may be able to modify the conversation summary before it is finalized.

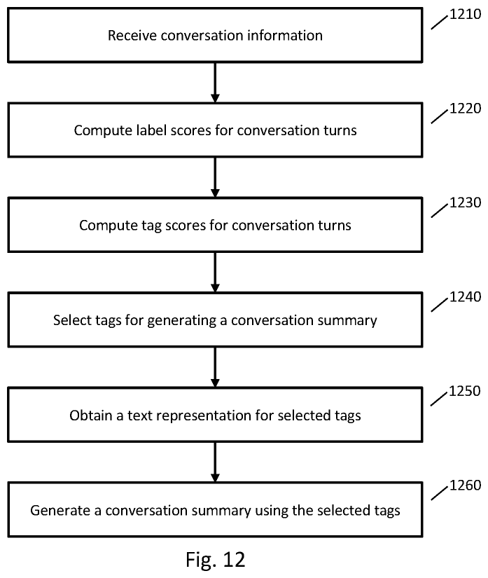

FIG. 12 is a flowchart of an example method for generating a summary of a conversation using a label space.

At step 1210, conversation information is received. Any appropriate conversation information may be received, such as text of a sequence of conversation turns. The conversation information may also include timing information (e.g., a timestamp or an index of a conversation in the sequence of conversation turns), information about users in the conversation (e.g., a user identifier, such as an identifier of an individual user or an identifier of a type of user). For example, the conversation turns may include a first conversation turn that corresponds to first text and a first user identifier and a second conversation turn that corresponds to second text and a second user identifier.

At step 1220, label scores are computed for the conversation turns. Label scores may be computed using any appropriate techniques, such as any of the techniques described herein. Any appropriate labels may be used, such as any of the labels described herein. For example, labels scores may be computed for a conversation turn by processing text of the conversation turn with a classifier. The label scores for a first conversation turn may include first label scores corresponding to a first label (e.g., dialogue acts) and second label scores corresponding to a second label (e.g., topic). The label scores for a second conversation turn may include third label scores corresponding to the first label (e.g., dialogue acts) and fourth label scores corresponding to a second label (e.g., topic).

At step 1230, tag scores are computed for tags of the conversation turns. Tag scores may be computed using any appropriate techniques, such as any of the techniques described herein. Any appropriate tags may be used, such as any of the tags described herein. For example, a tag may be determined by combining labels, and a tag score may be computed from the label scores corresponding to labels of the tag. In some implementations, a single tag score may be computed for a single tag of a conversation turn. In some implementations, multiple tag scores may be computed for multiple tags of a conversation turn. The tag scores for the first conversation turn may be computed using the first label scores and the second labels scores, and the tag scores for the second conversation turn may be computed using the third label scores and the fourth label scores.

At step 1240, a subset of tags is selected for generating a conversation summary. The subset of tags may be selected using any appropriate techniques, such as any of the techniques described herein. For example, a number of highest scoring tags may be selected.

At step 1250, a text representation is obtained for the subset of tags selected at step 1240. Any appropriate techniques may be used to obtain a text representation for a tag, such as any of the techniques described herein. In some implementations, the text representation for a tag may be determined in advance (e.g., by a person) and retrieved from a data store. In some implementations, the text representation for a tag may be generated using a neural network. In some implementations, a user identifier corresponding to the tag may be used to obtain a text representation of a tag.

At step 1260, a conversation summary is generated using the text representations of the selected tags. The conversation summary may be generated using any appropriate techniques, such as any of the techniques described herein. For example, the conversation summary may be a concatenation of the text representations of the selected tags or a bullet point presentation of the text representations of the selected tags. In some implementations, timing information, such as timestamps, may be used to generate the conversation summary.

The conversation summary may then be used for any appropriate business purpose. For example, the conversation may be presented to a user for review and possible modification, may be stored in a data store for later review or use, and may be indexed in a data store (e.g., by label and/or tag values) for business analysis

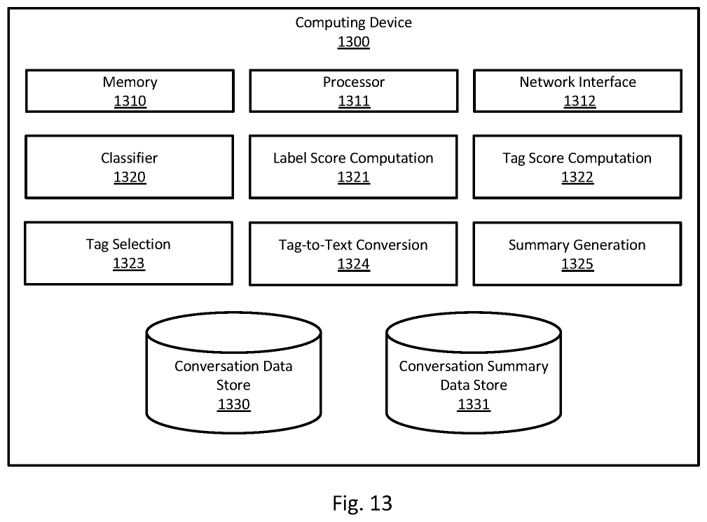

FIG. 13 illustrates components of one implementation of a computing device 1300 for implementing any of the techniques described herein. In FIG. 13, the components are shown as being on a single computing device, but the components may be distributed among multiple computing devices, such as a system of computing devices, including, for example, an end-user computing device (e.g., a smart phone or a tablet) and/or a server computer (e.g., cloud computing).

Computing device 1300 may include any components typical of a computing device, such as volatile or nonvolatile memory 1310, one or more processors 1311, and one or more network interfaces 1312. Computing device 1300 may also include any input and output components, such as displays, keyboards, and touch screens. Computing device 1300 may also include a variety of components or modules providing specific functionality, and these components or modules may be implemented in software, hardware, or a combination thereof. Computing device 1300 may include one or more non-transitory, computer-readable media comprising computer-executable instructions that, when executed, cause a processor to perform actions corresponding to any of the techniques described herein. Below, several examples of components are described for one example implementation, and other implementations may include additional components or exclude some of the components described below.

Computing device 1300 may have a classifier component 1320 that may process a conversation turn to compute classification scores using any of the techniques described herein. Computing device 1300 may have a label score computation component 1321 that may process a conversation turn to compute label scores using any of the techniques described herein. Computing device 1300 may have a tag score computation component 1322 that may process label scores of a conversation turn to compute tag scores using any of the techniques described herein. Computing device 1300 may have a tag selection component 1323 that may select a subset of tags using tag scores and using any of the techniques described herein. Computing device 1300 may have a tag-to-text component 1324 that may obtain a text representation of a tag using any of the techniques described herein. Computing device 1300 may have a summary generation component 1325 that may generate a summary of a conversation using text representations of selected tags and using any of the techniques described herein.

Computing device 1300 may include or have access to various data stores. Data stores may use any known storage technology such as files, relational databases, non-relational databases, or any non-transitory computer-readable media. Computing device 1300 may have a conversation data store 1330 that stores conversation information for facilitating conversations and for applications, such as the generation of conversation summaries. Computing device 1300 may have a conversation summary data store 1331 that stores conversation summaries, and which may be indexed by labels and/or tags corresponding to the conversation summaries.

The methods and systems described herein may be deployed in part or in whole through a machine that executes computer software, program codes, and/or instructions on a processor. “Processor” as used herein is meant to include at least one processor and unless context clearly indicates otherwise, the plural and the singular should be understood to be interchangeable. Any aspects of the present disclosure may be implemented as a computer-implemented method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference in their entirety.

What is claimed is:

1. A computer-implemented method, comprising:
receiving conversation information, wherein:
the conversation information comprises a sequence of conversation turns,
the sequence of conversation turns comprises a first conversation turn and a second conversation turn,
the first conversation turn corresponds to first text, and
the second conversation turn corresponds second text;
computing label scores by processing the sequence of conversation turns with one or more neural networks, wherein computing the label scores comprises:
computing, for the first conversation turn, first label scores for a first label and second label scores for a second label, and
computing, for the second conversation turn, third label scores for the first label and fourth label scores for the second label;
computing tag scores for tags by processing the label scores, wherein computing the tag scores comprises:
computing, for the first conversation turn, a first tag score for a first tag using the first label scores and the second label scores, and
computing, for the second conversation turn, a second tag score for a second tag using the third label scores and the fourth label scores;
selecting a subset of the tags using the tag scores, wherein selecting the subset of the tags comprises selecting the first tag using the first tag score and not selecting the second tag using the second tag score;
obtaining a first text representation of the first tag; and
generating a conversation summary using the first text representation of the first tag.

2. The computer-implemented method of claim 1, wherein the first text of the first conversation turn was obtained by performing speech recognition of audio.

3. The computer-implemented method of claim 1, wherein computing the first label scores comprises processing the first text with a convolutional neural network.

4. The computer-implemented method of claim 1, wherein computing the first tag score comprises processing a first label score of the first label scores and a second label score of the second label scores.

5. The computer-implemented method of claim 1, wherein computing the first tag scores comprises multiplying a first label score of the first label scores and a second label score of the second label scores.

6. The computer-implemented method of claim 1, wherein selecting the subset of the tags comprises determining a similarity between the first tag and the second tag.

7. The computer-implemented method of claim 1, wherein:
selecting the subset of the tags comprises selecting a third tag of a third conversation turn;
the computer-implemented method comprises obtaining a third text representation of the third tag; and
generating the conversation summary comprises concatenating the first text representation of the first tag with the third text representation of a third tag.

8. The computer-implemented method of claim 7, wherein:
the first conversation turn corresponds to a first timestamp;
the third conversation turn corresponds to a third timestamp; and
generating the conversation summary comprises ordering the first text representation and the third text representation using the first timestamp and the third timestamp.

9. A system, comprising:
at least one server computer comprising at least one processor and at least one memory, the at least one server computer configured to:
receive conversation information, wherein:
the conversation information comprises a sequence of conversation turns,
the sequence of conversation turns comprises a first conversation turn and a second conversation turn,
the first conversation turn corresponds to first text, and
the second conversation turn corresponds second text;
compute label scores by processing the sequence of conversation turns with one or more neural networks, wherein computing the label scores comprises:
computing, for the first conversation turn, first label scores for a first label and second label scores for a second label, and
computing, for the second conversation turn, third label scores for the first label and fourth label scores for the second label;
compute tag scores for tags by processing the label scores, wherein computing the tag scores comprises:
computing, for the first conversation turn, a first tag score for a first tag using the first label scores and the second label scores, and
computing, for the second conversation turn, a second tag score for a second tag using the third label scores and the fourth label scores;
select a subset of the tags using the tag scores, wherein selecting the subset of the tags comprises selecting the first tag using the first tag score and not selecting the second tag using the second tag score;
obtain a first text representation of the first tag; and
generate a conversation summary using the first text representation of the first tag.

10. The system of claim 9, wherein:
the first conversation turn corresponds to a first user identifier;
the second conversation turn corresponds to a second user identifier; and
obtaining the first text representation of the first tag comprises using the first user identifier.

11. The system of claim 10, wherein the first user identifier corresponds to a customer and the second user identifier corresponds to an agent.

12. The system of claim 9, wherein obtaining the first text representation of the first tag comprises retrieving the first text representation of the first tag from a data store.

13. The system of claim 9, comprising presenting the conversation summary to a user.

14. The system of claim 13, comprising receiving an input from the user to modify the conversation summary.

15. The system of claim 9, comprising storing the conversation summary in a data store, wherein the data store is indexed using the first label.

16. The system of claim 9, wherein computing the first label scores comprises processing the first text with a classifier.

17. One or more non-transitory, computer-readable media comprising computer-executable instructions that, when executed, cause at least one processor to perform actions comprising:
receiving conversation information, wherein:
the conversation information comprises a sequence of conversation turns,
the sequence of conversation turns comprises a first conversation turn and a second conversation turn,
the first conversation turn corresponds to first text, and
the second conversation turn corresponds second text;
computing label scores by processing the sequence of conversation turns with one or more neural networks, wherein computing the label scores comprises:
computing, for the first conversation turn, first label scores for a first label and second label scores for a second label, and
computing, for the second conversation turn, third label scores for the first label and fourth label scores for the second label;
computing tag scores for tags by processing the label scores, wherein computing the tag scores comprises:
computing, for the first conversation turn, a first tag score for a first tag using the first label scores and the second label scores, and
computing, for the second conversation turn, a second tag score for a second tag using the third label scores and the fourth label scores;
selecting a subset of the tags using the tag scores, wherein selecting the subset of the tags comprises selecting the first tag using the first tag score and not selecting the second tag using the second tag score;
obtaining a first text representation of the first tag; and
generating a conversation summary using the first text representation of the first tag.

18. The one or more non-transitory, computer-readable media of claim 17, wherein the first label corresponds to dialog acts and the second label corresponds to topics.

19. The one or more non-transitory, computer-readable media of claim 17, wherein selecting the subset of the tags comprises selecting tags above a threshold.

20. The one or more non-transitory, computer-readable media of claim 17, wherein selecting the subset of the tags comprises determining a similarity between the first tag and the second tag.
